(19) United States
(12) Patent Application Publication
(10) Pub. No.: US 2007/0204498 A1
(43) Pub. Date: Sep. 6, 2007

(54) Emergency Information Tag

(76) Inventor: Jerry Dewayne Clevenger, Flag Pond, TN (US)

Correspondence Address: QUICKPATENTS, INC., 32861 CALLE PERFECTO, SUITE A, SAN JUAN CAPISTRANO, CA, 92675, US

(21) Appl. No.: 11/307,982

(22) Filed: Mar. 1, 2006

(51) Int. Cl. G09F 3/10

(52) U.S. Cl. 40/672

(57) ABSTRACT

An emergency information tag is disclosed, the tag comprising a sheet of material having a top surface, a bottom surface, and at least one edge surface. The bottom surface includes a plurality of identification information zones applied thereto, each of which includes a writable surface area for writing identification and medical information of a user. An emergency indicia notice is applied to the top surface of the sheet. The tag includes an attachment means attached to the top surface of the sheet, such as a loop of nylon material sewn to the top surface of the sheet and a key ring traversing the loop and captured thereby. The tag further includes a fastener comprising a first part and a second part. Each part is fixed separately to the top surface of the sheet. Preferably the fastener is a hook-and-loop type fastening material. In use, identity information is written onto the writable surface area of each identification information zone of the tag while the tag is in a flat configuration. The sheet may then be folded such that the two parts of the fastener are folded into each other to form a bundle configuration. The key ring may be attached to a zipper of a jacket, or the like, such that the tag is readily visible in the event of an emergency.

### CROSS-REFERENCE TO RELATED APPLICATIONS

Not applicable.

### STATEMENT REGARDING FEDERALLY SPONSORED RESEARCH AND DEVELOPMENT

Not Applicable.

### FIELD OF THE INVENTION

This invention relates to identification tags, and more particularly to an emergency information tag for attaching to clothing.

### DISCUSSION OF RELATED ART

Motorcyclists thrown from their motorcycle in a traffic accident are often separated from any identification information that may be located in, for example, a wallet that is located in a storage compartment of the motorcycle. As such, emergency medical personnel frequently have to go looking for identification and emergency medical information apart from the accident victim. This not only wastes critical treatment time of the accident victim, but there is no guarantee that identification information found on a vehicle is associated with a particular accident victim, unless there is a clear photo identification or the like. On the other hand, providing emergency medical aid to an accident victim without knowing if the victim has any allergies or medical conditions is equally risky. Consequently, there is a need for an emergency identification tag that remains with the motorcyclist, being preferably fixed to an article of clothing worn by the motorcyclist every time he rides.

Emergency information tags are known in the art, one of which, by way of example, is taught in US Patent Application 2004/0111942 to Stonehocker on Jun. 17, 2004. Such a device is a plastic clam-shell type tag that attaches in various ways to shoelaces, belts, or the like. However, such a tag is not suitable for use on a motorcyclist while riding in inclement weather since rain can easily enter the inside of the clamshell of such a device and render any writing therein illegible. Further, such a design provides only a small surface area for writing, which limits the amount of identification and emergency medical information that can be included with such a device. Yet making such a device larger to accommodate the writing of more information therein makes this type of device too bulky to be practical. Further, this type of device may not be easily nor securely attached to the zipper of a leather jacket, for example.

Similar drawbacks exist for the prior art device taught in U.S. Pat. No. 6,679,405 to Zalis-Hecker et al. on Jan. 20, 2004. Such a device is considerably too small to fit many medical facts and personal identification information, and is designed more as a storage pouch than an emergency medical tag.

U.S. Pat. No. 5,312,136 to Capozzola on May 17, 1994, teaches an identification tag for including in a person's shoe. While such a device is made large enough to store sufficient identification and medical information, the preferred placement of such a device in motorcyclist's shoe not only may be uncomfortable, but will likely not be found in a timely manner by medical personnel when most needed. Few will think to look in the person's shoe in the off-chance that such a device will be located there.

U.S. Pat. No. 4,375,133 to Fenrich et al. on Mar. 1, 1983 teaches a jogger's identification tag. Such a device is pinned to an article of clothing of a jogger and contains a tag that, again, is too small to effectively contain a practical amount of information. Further, attaching such a device to a leather jacket, in particular, is not practical as the pins of such a device necessarily puncture the garment to which they are attached, causing permanent damage.

Luggage tags are well known in the prior art, many of which have slide-out information cards. However, such tags are often bulky and not suited for compact storage on the garment of a person. Such tags that are compact, however, are typically too compact to provide enough writing space for detailed contact information and medical data.

U.S. Pat. No. 3,921,318 to Calavetta on Nov. 25, 1975 teaches a body-carried medical history card. Such a device includes a microfilm section containing detailed medical history of the user. However, such a device is best suited for storing in a wallet, and is not adapted nor adaptable to being clipped onto a garment, or the like.

Therefore, there is a need for compact emergency medical tag that is readily attachable to the garment of a motorcyclist, outdoor enthusiast, sportsman, or the like. The needed tag would be essentially waterproof, or at least water resistant, and would be strong and durable. Such a needed device would provide a large enough writing space to provide detailed identification and medical information of the user, yet would be compact when in its normal configuration on the garment. Such a needed device would be readily noticeable by medical personnel, or the like, and would stay with the user under most circumstances where it might be required. The present invention accomplishes these and other objectives.

### SUMMARY OF THE INVENTION

The present invention is an emergency information tag comprising a sheet of material having a top surface, a bottom surface, and at least one edge surface. The bottom surface includes a plurality of identification information zones applied thereto, each of which includes a writable surface area for writing identification and medical information of a user. An emergency indicia notice is applied to the top surface of the sheet.

The tag includes an attachment means attached to the top surface of the sheet. Preferably the attachment means comprises a loop of nylon material sewn to the top surface of the sheet, and a key ring traversing the loop and captured thereby. The key ring may then be fastened to a zipper of a jacket of the user, or the like.

The tag further includes a fastener comprising a first part and a second part. Each part is fixed separately to the top surface of the sheet. Preferably the fastener is a hook-and-loop type fastening material.

In use, identity information is written onto the writable surface area of each identification information zone of the tag while the tag is in a flat configuration. The sheet may then be folded such that the two parts of the fastener are folded into each other to form a bundle configuration. The attachment means may be attached to a zipper of a jacket, or the like, such that the tag is readily visible in the event of an emergency. For example, if the tag is attached to a motorcyclist's leather riding jacket, and the motorcyclist is thrown from his vehicle in an accident, emergency medical personnel will be alerted to the tag by the bright and contrasting colors of the sheet and emergency indicia notice. Upon quick opening of the bundled configuration of the tag to the flat configuration, important medical and identify information will be readily at hand to aid in the treatment of the user.

The tag is waterproof to withstand rain, and when in the bundled configuration water is unable to easily reach the folded-up back surface that contains the identity information. Further, the tag is highly durable and can withstand strong mechanical forces associated with a traffic accident without being damaged.

The present invention is compact emergency medical tag that is readily attachable to the garment of a motorcyclist, outdoor enthusiast, sportsman, or the like. The present tag is highly water resistant, strong and durable. The present invention provides a large writing space for detailed identification and medical information of the user, yet is compact when in its normal bundled configuration when attached to a garment, or the like. The tag of the present invention is readily noticeable by medical personnel, and stays with the user under most circumstances where it might be required, such as in a traffic accident, skiing accident, or the like. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a top plan view of a top surface of a sheet of a tag of the invention, the tag being in a flat configuration;

FIG. 2 is a bottom plan view of a bottom surface of the sheet of the tag of the invention, the tag being in the flat configuration;

FIG. 3 is a top plan view of the tag of the invention, the tag being in a bundled configuration;

FIG. 4 is a bottom plan view of the tag of the invention, the tag being in the bundled configuration;

FIG. 5 is a bottom plan view of the invention, illustrating the sheet of the invention as being folded over twice horizontally;

FIG. 6 is a bottom plan view of the invention, illustrating the sheet of the invention as being folded over twice horizontally, and then twice vertically, and further illustrating two parts of a fastener having been brought into mutual adjacent alignment.

### DETAILED DESCRIPTION OF THE PREFERRED EMBODIMENT

The present invention is an emergency information tag 10 comprising a sheet 20 of material 25 having a top surface 22, a bottom surface 24, and at least one edge surface 26. The bottom surface 24 includes a plurality of identification information zones 30 applied thereto, each of which includes a writable surface area 35 (FIG. 2).

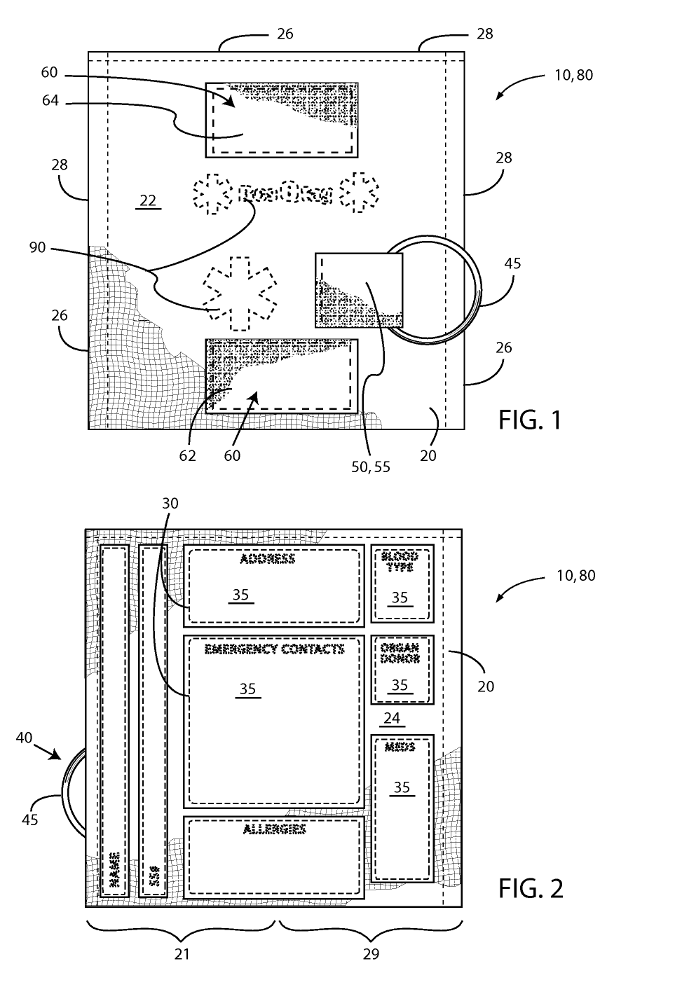

The material 25 may be made of nylon, or any other strong, waterproof, and durable material. Preferably the sheet 20 is made from a larger blank with printing only on one side (not shown), folded in half, and then sewn, heat sealed, or otherwise bonded along the resulting three open edges 28 (FIGS. 1 and 2). As such, an emergency indicia notice 90 may be applied to the same side of the blank as the identification information zones 30, the result after folding and sewing being that the identification information zones 30 are on the back surface 24 of the sheet 20 and the emergency indicia notice 90 is on the front surface 22 of the sheet 20. In this manner two-sided printing of the material 25 is avoided, and the resulting sheet 20 comprises two layers of the material 25, increasing its durability. The emergency indicia notice 90 and the identification information zones 30 are preferably printed in white ink, and the sheet material 25 is preferably made from a highly visible color such as red or a bright fluorescent color that contrasts with the white ink. Alternately, a white or very light colored material 25 may be used, and the ink for the emergency indicia notice 90 and the identification information zones 30 may be a bright highly-contrasting color such as red or a bright fluorescent color. Clearly, however, any choice of suitably contrasting colors may be used for the material 25 and the ink used for printing thereon, provided the ink forms a surface suitable for accepting and retaining writing of identification information.

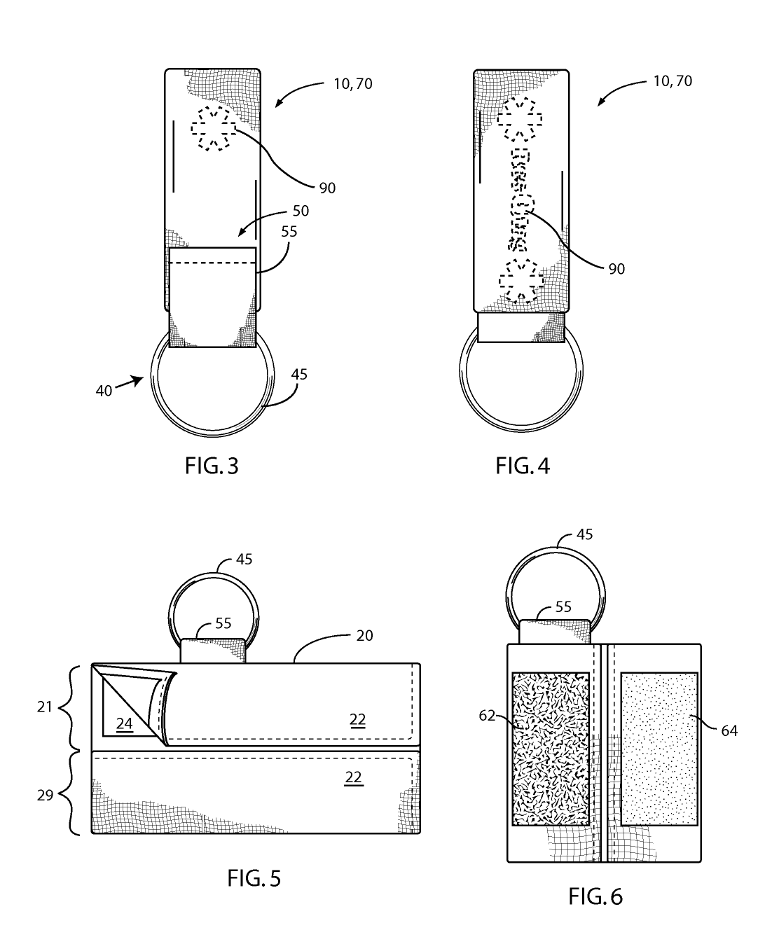

The tag 10 includes an attachment means 40 attached to the top surface 22 of the sheet 20 (FIGS. 1 and 3). Preferably the attachment means 40 comprises a loop 55 of nylon material sewn, heat sealed, or otherwise bonded to the top surface 22 of the sheet 20, and a key ring 45 traversing the loop 55 and captured thereby (FIGS. 1 and 3). The key ring 45 may then be fastened to a zipper of a jacket (not shown), or the like. Alternately, the key ring 45 may be a spring-biased clip or other temporary attachment means as is known in the art (not shown).

The tag 10 further includes a fastener 60 comprising a first part 62 and a second part 64. Each part 62,64 is fixed separately to the top surface 22 of the sheet 20. Preferably the fastener 60 is a hook-and-loop type fastening material, such that the first part 62 is a hook material and the second part 64 is a loop material (FIGS. 1 and 6). Alternately, the fastener 60 may be a snap fastener (not shown).

In use, identity information is written onto the writable surface area 35 of each identification information zone 30 of the tag 10 while the tag 10 is in a flat configuration 80 (FIG. 2). The information is preferably applied using permanent ink, such as from a Sharpie® brand of pen, or the like. Once the ink has dried, the sheet 20 may be folded twice such that a top half of the bottom surface 25 is folded over upon itself, and a bottom half of the bottom surface 24 is folded over upon itself, as illustrated in FIG. 5. Then the sheet 20 is folded twice again in the same manner, but this time vertically, such that the two parts 62,64 of the fastener 60 become adjacently aligned, as illustrated in FIG. 6. Finally, the two parts 62,64 are folded into each other to form a bundle configuration 70, as illustrated in FIGS. 3 and 4.

The attachment means 40 may be attached to a zipper of a jacket (not shown), or the like, such that the tag 10 is readily visible in the event of an emergency. For example, if the tag 10 is attached to a motorcyclist's leather riding jacket, and the motorcyclist is thrown from his vehicle in an accident, emergency medical personnel will be alerted to the tag 10 by the bright and contrasting colors of the sheet 20 and emergency indicia notice 90. Upon quick opening of the bundled configuration 70 of the tag 10 to the flat configuration 80, important medical and identify information will be readily at hand to aid in the treatment of the user.

The tag 10 is waterproof to withstand rain, and when in the bundled configuration 70 water is unable to easily reach the folded-up back surface 24 that contains the identity information. Indeed, even if the identity information is written with a water-soluble ink, water will not be able to damage the written information. Further, the tag 10 is highly durable and can withstand strong mechanical forces associated with a traffic accident without being damaged.

While a particular form of the invention has been illustrated and described, it will be apparent that various modifications can be made without departing from the spirit and scope of the invention. For example, the type of attachment means 40 used may be varied according to the item to which the tag 10 is to be attached. A mountain climber may need a device that is more readily attachable to a belt clip, for example, than a zipper. Further, the information zones 30 may be varied according to specific applications as well, in that motorcyclists may wish for name, social security number, address, emergency contacts, allergies, blood type, organ donor status, and current medications may be included. Alternately, however, military personnel may need their unit identification included as well, and perhaps their rank and serial number. Accordingly, it is not intended that the invention be limited, except as by the appended claims.

1-11. (canceled)

12. An emergency information tag comprising:
a sheet of material having a top surface, a bottom surface, and at least one edge surface, the bottom surface having identification information zones applied thereto, each identification information zone including a writable surface area;
an attachment means attached to the top surface of the sheet; and
a fastener comprising a first part and a second part, each part fixed separately to the top surface of the sheet such that for the first and second parts of the fastener to contact each other and to prevent water from being able to easily reach the back surface, the sheet must be folded twice horizontally such that a top half of the bottom surface is folded over upon itself and a bottom half of the bottom surface is folded over upon itself, and then folded twice again, but vertically, so that the first and second part of the fastener become adjacently aligned, and then folded once again vertically to form a bundle configuration;
whereby the sheet may be folded into the bundle configuration, and whereby the two fastener parts may be separated and the sheet unfolded into a flat configuration so as to make the identification information zones visible.

13. The emergency information tag of claim 12 wherein the bundled configuration includes at least 8 layers of the sheet in cross-section.

14. The emergency information tag of claim 12 wherein the sheet of material is nylon.

15. The emergency information tag of claim 12 wherein the fastener is a hook-and-loop type fastener.

16. The emergency information tag of claim 12 where in the attachment means is a loop of nylon material bonded to the sheet, and a key ring traversing the loop of nylon.

17. The emergency information tag of claim 12 wherein the sheet of material comprises a larger blank folded in half, and bonded along the resulting three open edges, such that the bundled configuration thereof includes at least 16 layers of the sheet in cross-section.

18. The emergency information tag of claim 12 wherein the top surface includes an emergency indicia notice applied thereto.
